(19) United States
(12) Patent Application Publication
(10) Pub. No.: US 2026/0041177 A1
(43) Pub. Date: Feb. 12, 2026

(54) Mask

(71) Applicant: KOKEN LTD., Tokyo (JP)

(72) Inventors: Haruka SUGITA, Tokyo (JP); Daishi SATO, Tokyo (JP)

(73) Assignee: KOKEN LTD., Tokyo (JP)

(21) Appl. No.: 19/099,707

(22) PCT Filed: Jul. 21, 2023
(86) PCT No.: PCT/JP2023/026758

§ 371 Date: Jan. 29, 2025

(30) Foreign Application Priority Data
Aug. 2, 2022 (JP) 2022-123587

(51) Int. Cl. A41D 13/11; A62B 18/08; A62B 23/02

(52) U.S. Cl. CPC A41D 13/1161; A62B 18/084; A62B 23/025

(57) ABSTRACT

To provide a mask which can easily form a three-dimensional shape that ensures favorable adherence to the face of a wearer when in use and which can easily be maintained in a favorable state of use. A mask 1 includes: a mask body part 2 which is exposed to the outside; and ear straps 4, 4 on respective sides of the mask body part 2, wherein the mask body part 2 includes a central portion 6 which covers a central part of the face of the wearer along a longitudinal direction, folded parts 7, 7 which are connected to the sides of the central portion 6 and which are folded along the longitudinal direction of the mask body part 2, and side parts 8, 8 which are connected to sides of the folded parts 7, 7 and which cover the sides of the face of the wearer, the central portion 6 includes upper reduced-width parts 10, 10 and lower reduced-width parts 11, 11 each having a width in the left-right direction reduced upward and downward from a central part, and in the mask body part 2, the folded parts 7, 7 are folded when the mask 1 is not in use and the folded parts 7, 7 are erected by tension of the ear straps 4, 4 and form a three-dimensional shape when the mask 1 is in use.

### TECHNICAL FIELD

The present invention relates to a mask suitable for various applications such as a household mask and a medical mask.

### BACKGROUND ART

Conventionally, various types of masks are used for various purposes such as preventing a wearer from inhaling external harmful substances or viruses and preventing airborne droplets and the like contained in the exhalation of the wearer from being dispersed outside. The various types of masks are then folded into a flat shape when not in use and unfolded into a three-dimensional shape that can cover the nose and mouth area when in use. Patent Literatures 1 and 2 are conventionally known as inventions related to various types of masks in which a flat shape is made into a three-dimensional shape when in use.

Patent Literature 1 describes a configuration including: a central panel including an upper end edge and a lower end edge which transversely extend and oppose each other and a left side edge and a right side edge which vertically extend and oppose each other; and a first panel and a second panel connected to the upper end edge and the lower end edge of the central panel, respectively, in which a pair of first joining lines and second joining lines to which the central panel and the second panel are joined are joined to each other, and two end edges positioned on the upper end edge are separated from each other.

Patent Literature 2 describes a horizontally foldable mask including: a body including, in a folded state, a middle piece, an upper piece an upper end part of which curves downward from a center to both sides, a lower piece a lower end part of which curves upward from a center to both sides, a first fold which extends upward from the middle piece, which is folded horizontally from the upper piece, and which has a first intermediate fold curve, and a second fold which extends downward from the middle piece, which is folded horizontally from the lower piece, and which has a second intermediate fold curve; and a harness which is fixed to both sides of the body.

### CITATION LIST

### Patent Literature

Patent Literature 1: Japanese U.S. Pat. No. 4,794,291
Patent Literature 2: Japanese Translation of PCT International Application Publication No. 2021-514427

### SUMMARY OF INVENTION

### Technical Problem

Protrusions and depressions of the nose and mouth of a wearer are mainly formed along an approximately vertical direction of the face. However, a pleat formed by the first and second joining lines according to Patent Literature 1 and a pleat formed by first and second intermediate fold curves according to Patent Literature 2 are formed along an approximately horizontal direction of a mask body. Therefore, in the masks described in Patent Literature 1 and Patent Literature 2, a three-dimensional shape is formed by a pleat in an approximately horizontal direction with respect to the face of the wearer. As a result, the masks described in Patent Literature 1 and Patent Literature 2 have a problem in that forming a three-dimensional shape that corresponds to the shape of the face of the wearer is difficult, making it a challenge to fit and adhere the masks to the face. In addition, in the inventions described in Patent Literature 1 and Patent Literature 2, a force applied in a direction of spreading to the left or right by ear straps when wearing the masks are roughly in line with the direction of the pleats. Therefore, a force applied to the mask body by the ear straps is less likely to act effectively to form the mask body into a three-dimensional shape that follows the shape of the face of the wearer. As a result, in the inventions described in Patent Literature 1 and Patent Literature 2, there is a problem in that an appropriate three-dimensional shape is not formed, making it a challenge to keep the mask body in close contact with a periphery of the wearer's nose and mouth and to maintain a favorable state of use.

The present invention has been made in consideration of such problems and an object thereof is to provide a mask which can easily form a three-dimensional shape that ensures favorable adherence to the face of the wearer when in use and which can easily be maintained in a favorable state of use.

### Solution to Problem

In order to achieve the object described above, a feature of the present invention is a mask including: a mask body part which is exposed to the outside when worn on the face of a wearer; and ear straps arranged on respective sides of the mask body part, wherein the mask body part includes a central portion which covers a central part in a left-right direction of the face of the wearer along a longitudinal direction, folded parts which are connected to sides of the central portion and which are folded along the longitudinal direction of the mask body part, and side parts which are connected to the sides of the folded parts and which cover the sides of the face of the wearer, the central portion includes reduced-width parts each having a width in the left-right direction reduced upward and/or downward from the central part in the up-down direction, and the mask body part is configured such that the folded parts are folded and form a flap shape when the wearer is not using the mask and the folded parts are erected by tension of the ear straps to form a three-dimensional shape when the wearer is using the mask.

A preferable embodiment of the present invention includes first pleat fold lines formed at respective borders between the folded parts and the central portion and second pleat fold lines formed at respective borders between the folded parts and the side parts, wherein respective upper end parts and/or respective lower end parts of the first pleat fold lines and the second pleat fold lines are formed at approximately the same respective positions.

In a preferable embodiment of the present invention, the central portion includes vertical parts which are positioned at least in the central part in the up-down direction and which are provided in an approximately vertical direction and the reduced-width portions which are positioned and provided above and/or below the respective vertical parts, wherein the ear straps are connected to the mask body part at respective upper and lower positions approximately equal to border parts between the respective vertical parts and the respective reduced-width parts and/or at respective upper and lower positions closer to the central part in the up-down direction than the border parts.

In a preferable embodiment of the present invention, respective attachment portions of the ear straps to the mask body part are connected to the mask body part at positions in the up-down direction where the reduced-width parts are provided which are positions in the up-down direction approximately equally distanced from an upper end and a lower end of the mask body part.

A preferable embodiment of the present invention includes a facial contact body which is provided on an inner side of the mask body part and which comes into contact with the face of the wearer.

### Advantageous Effects of Invention

In the mask according to the present invention, the mask includes a central portion, folded parts which are folded along a longitudinal direction of a mask body part, and side parts which are connected to the sides of the folded parts, so that a three-dimensional shape along a longitudinal direction of the mask body is formed. The three-dimensional shape can easily accommodate the irregularities of the face of the wearer and allows the mask to be worn stably in a state of close contact with a periphery of the wearer's nose and mouth area. In addition, the central portion includes reduced-width parts each having a width in the left-right direction reduced upward and/or downward from the central part in the up-down direction, so that the folded parts are smoothly erected by a force applied in the left-right direction of the mask body part due to tension of the ear straps or the like to form a three-dimensional shape and the three-dimensional shape with a raised central portion of the mask body part can thus be easily formed and maintained. Accordingly, a mask which can easily form a three-dimensional shape that ensures favorable adherence to the face of the wearer when in use and which can easily be maintained in a favorable state of use can be provided.

In addition, in the mask according to the present invention, respective upper end parts and/or respective lower end parts of first pleat fold lines formed at respective borders between the folded parts and the central portion and second pleat fold lines formed at respective borders between the folded parts and the side parts are formed at approximately the same respective positions, so that, even when the upper end parts and the lower end parts of the mask body part and the folded parts are joined including the pleat fold lines, a state of the joint can be prevented from affecting the erection of the folded parts. Accordingly, a mask can be provided which easily enables the three-dimensional shape of the mask body part corresponding to the three-dimensional shape of the face of the wearer to be appropriately formed and maintained and which can be used while maintaining a comfortable fit.

Furthermore, in the mask according to the present invention, the central portion includes reduced-width parts each having a width in the left-right direction reduced upward and/or downward from the central part in the up-down direction, so that the folded parts are smoothly erected by a force applied in the left-right direction of the mask body part due to tension of the ear straps or the like to form a three-dimensional shape and the three-dimensional shape with the raised central portion of the mask body part can thus be easily formed and maintained. In addition, a protruding part includes a tip part formed with a predetermined length along the up-down direction, and when the wearer wears the mask, the tip part of the protruding part comes into contact with the central portion or the folded parts and presses the central portion from the inside to the outside, thereby enabling the folded parts to be easily erected and form a three-dimensional shape. Accordingly, a shape corresponding to the three-dimensional shape of the face of the wearer can be more easily formed and maintained, ensuring a comfortable fit for the wearer and even more favorable adherence to the face of the wearer.

In addition, in the mask according to the present invention, the respective attachment portions of the ear straps to the mask body part are connected to the mask body part at positions in the up-down direction where the reduced-width parts are provided which are positions in the up-down direction approximately equally distanced from an upper end and a lower end of the mask body part, so that the folded parts of the mask body part can be erected and the three-dimensional shape can be stably maintained by tension in the left-right direction produced by the ear straps when in use.

Furthermore, since the mask according to the present invention includes a facial contact body which is provided on an inner side and which comes into contact with the face of the wearer so that the mask can be easily and snugly attached to the face of the wearer, the wearer can be reliably prevented from inhaling external harmful substances or viruses and airborne droplets and the like contained in the exhalation of the wearer can be reliably prevented from being dispersed outside.

### BRIEF DESCRIPTION OF DRAWINGS

FIG. 1 is a front view showing a mask according to an embodiment.

FIG. 2 is a rear view showing the mask according to the embodiment.

FIG. 3 is a plan view showing the mask according to the embodiment.

FIG. 4 is a sectional view taken along line A-A in FIG. 2.

FIG. 5 is a sectional view taken at a position of line A-A in FIG. 2 in a state where the mask according to the embodiment is made into a three-dimensional shape.

FIG. 6 is a diagram of a state where a wearer is wearing the mask according to the embodiment as viewed from the front.

FIG. 7 is a diagram of a state where the wearer is wearing the mask according to the embodiment as viewed obliquely.

FIG. 8 is a sectional view taken at a position of line B-B in FIG. 1 in a state where the mask according to the embodiment is made into a three-dimensional shape.

FIG. 9 is a diagram showing a state where the wearer is wearing the mask according to the embodiment as viewed from a rear side.

FIG. 10 is a sectional view taken at a position of line E-E in FIG. 6 in a state where the wearer is wearing the mask according to the embodiment.

FIG. 11 is a schematic diagram showing an example of a [first modification] of the mask according to the embodiment.

FIG. 12 is a schematic diagram showing an example of the [first modification] of the mask according to the embodiment.

FIG. 13 is a schematic diagram showing an example of the [first modification] of the mask according to the embodiment.

FIG. 14 is a schematic diagram showing an example of a [second modification] of the mask according to the embodiment.

FIG. 15 is a schematic diagram showing an example of the [second modification] of the mask according to the embodiment.

FIG. 16 is a schematic diagram showing an example of the [second modification] of the mask according to the embodiment.

FIG. 17 is a schematic diagram showing an example of the [second modification] of the mask according to the embodiment.

FIG. 18 is a schematic diagram showing an example of a [third modification] of the mask according to the embodiment.

FIG. 19 is a schematic diagram showing an example of the [third modification] of the mask according to the embodiment.

FIG. 20 is a schematic diagram showing an example of the [third modification] of the mask according to the embodiment.

### DESCRIPTION OF EMBODIMENT

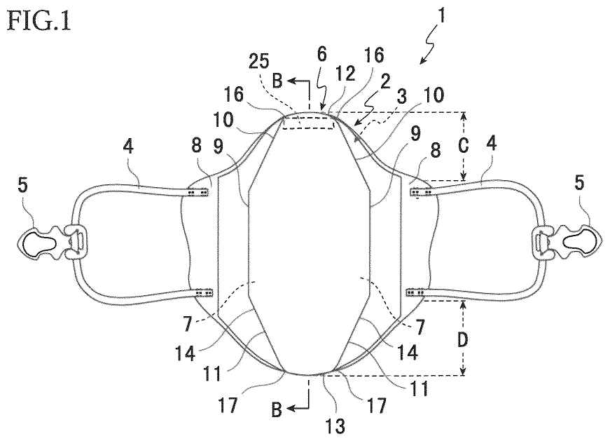

Hereinafter, a mask according to an embodiment of the present invention will be described with reference to FIGS. 1 to 10.

### Overall Configuration of Mask

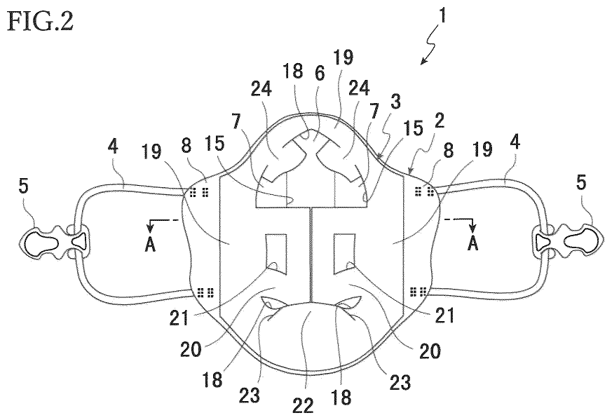

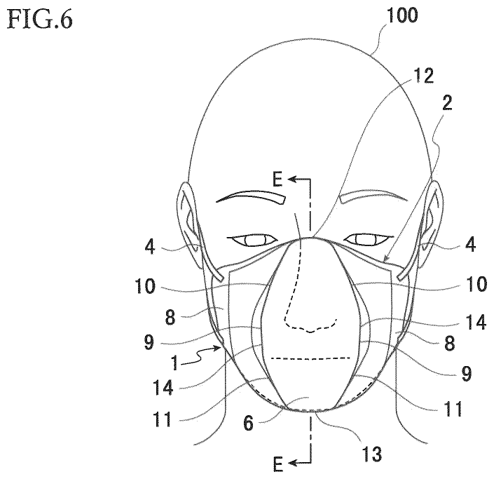

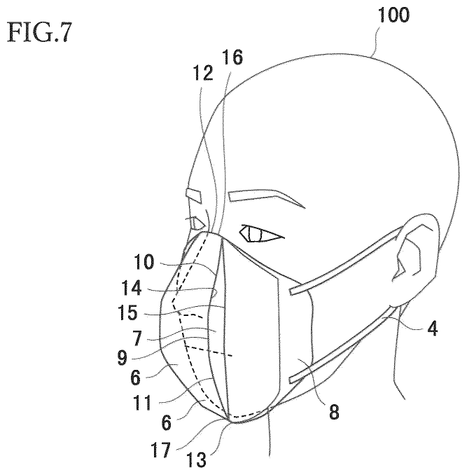

A mask 1 according to the present embodiment shown in FIGS. 1 and 2 is, for example, a household mask which is a so-called pleated non-woven mask used primarily to inhibit inhalation of particles such as pollen and dust and to control the dispersal of airborne droplets contained in the exhalation of a wearer 100 (refer to FIGS. 6 and 7). However, the mask 1 according to the present embodiment may be used for non-woven masks without pleats or used for various purposes including cold prevention and medical use.

As shown in FIGS. 1 and 2, the mask 1 according to the present embodiment has a mask body part 2, a facial contact body 3 which comes into contact with the face of the wearer 100, a pair of left and right ear straps 4, 4 that are hung on the left and right ears of the wearer 100, respectively, and strap clips 5, 5 for the ear straps 4, 4, respectively.

### Outline of Mask Body Part

The mask body part 2 is made of a breathable sheet material which is a material such as a non-woven fabric that is both breathable and capable of inhibiting passage of particles such as pollen, dust, or airborne droplets contained in the exhalation of the wearer 100.

As shown in FIG. 1, the mask body part 2 is formed in an octagonal shape in a front view as a whole. This is a shape suitable for coming into close contact with and covering a periphery of the nose and mouth area of the wearer 100. Specifically, this is a shape that is almost the same as a shape formed by connecting portions from the nose to the mouth area which are less uneven and at about the same height (which can easily be brought into close contact without creating gaps). Making the mask body part 2 in such a shape ensures a favorable fit state. However, any shape (for example, an approximately hexagonal shape or an approximately elliptical shape) in a front view other than an approximately octagonal shape may be adopted as long as the shape is able to come into close contact with and cover the periphery of the nose and mouth area of the wearer 100.

The mask body part 2 is formed, for example, in a folded state in the front view shown in FIG. 2 with a length in a left-right direction and a length in an up-down direction of approximately 120 mm to 180 mm, respectively (the lengths vary depending on a size of the mask 1 and the like). However, the mask body part 2 is not limited to these dimensions as long as the dimensions of the mask body part 2 enables the mask body part 2 to come into close contact with the face of the wearer 100 when in use to provide a favorable fit state and enables a dust-preventing function and an airborne droplet-preventing function to be realized.

The mask body part 2 is stacked in a plurality of layers. Specifically, for example, the following layers are stacked in order from an outer side toward an inner side: a pre-filter which adsorbs moisture and which has a large fiber diameter for filtering large dust particles to improve appearance, a main filter which has a small fiber diameter for filtering fine dust particles, and a water absorption filter which mainly absorbs moisture contained in the exhalation of the wearer 100 (all not illustrated). Note that a material of the mask body part 2 is not particularly limited as long as the material is soft and bendable, capable of taking in inhalation and discharging exhalation of the wearer 100, and capable of functioning as a filter part that can filter inhalation, external pollen, dust, and the like.

### Details of Mask Body Part

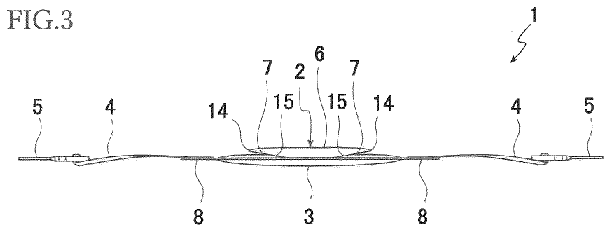

In a front view or a plan view, the mask body part 2 is made up of the following five components: a central portion 6, a pair of folded parts 7, 7 provided to the side on left and right sides of the central portion 6 (the left and right sides in FIGS. 1 and 3: the same description applies in the present specification), and a pair of side parts 8, 8 provided to the side on left and right sides of the folded parts 7. However, the mask body part 2 may include more than the five components of the central portion 6, the folded parts 7, 7, and the side parts 8, 8.

The central portion 6 is configured to cover a central part in a left-right direction of the face of the wearer 100 along an up-down direction (the up-down direction in FIGS. 1 and 2: the same description applies in the present specification) as the “longitudinal direction”.

As shown in FIG. 1, the central portion 6 is formed in an approximately octagonal shape in a front view which includes a pair of vertical parts 9, 9, upper reduced-width parts 10, 10 as “reduced-width parts” respectively positioned and provided above the vertical parts 9, 9, lower reduced-width parts 11, 11 as “reduced-width parts” respectively positioned and provided below the vertical parts 9, 9, an upper end part 12, and a lower end part 13. The vertical parts 9, 9 of the central portion 6 are formed so that a length of the vertical parts 9, 9 in the left-right direction ranges from approximately 40 mm to 100 mm. In addition, although the central portion 6 is desirably formed with a length-to-width ratio of about 1.5 to 3.3:1, the central portion 6 is not limited to this range as long as a favorable fit state, a dust-preventing function, and an airborne droplet-preventing function can be realized.

The vertical parts 9, 9 are formed parallel to each other along the up-down direction in a central part of the up-down direction in a front view.

The upper reduced-width parts 10, 10 are formed so that their sizes in the left-right direction gradually decrease upward in the up-down direction.

The lower reduced-width parts 11, 11 are formed so that their sizes in the left-right direction gradually decrease downward in the up-down direction.

The upper end part 12 and the lower end part 13 are formed in shapes that conform to an upper end and a lower end of the mask body part 2. The upper end part 12 is formed in a curved shape that is convex upward and the lower end part 13 is formed in a curved shape that is convex downward, respectively.

The folded parts 7, 7 are connected to the sides of the central portion 6, respectively. As shown in FIG. 3, the folded parts 7, 7 are folded along the longitudinal direction of the mask body part 2 when not in use and, as shown in FIG. 7, erected when in use so that the mask body part 2 and the facial contact body 3 form three-dimensional shapes.

As shown in FIG. 3, the side parts 8, 8 are provided connected to the sides of the folded parts 7, 7. As shown in FIGS. 6 and 7, the side parts 8, 8 are configured to cover the sides of the face of the wearer 100.

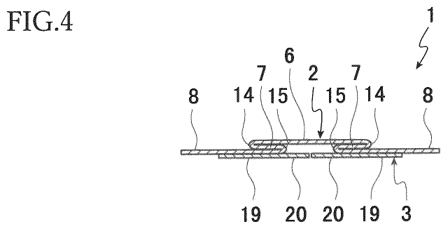

As shown in FIG. 4, first pleat fold lines 14, 14 are formed as mountain fold lines as viewed from a front side of the mask body part 2 at a border between the central portion 6 and each of the folded parts 7, 7. The first pleat fold lines 14, 14 are formed in a shape of a fold line in an approximately vertical direction at the positions of the vertical parts 9 of the central portion 6 and formed in shapes respectively inclined upward and downward in a reduced-width direction at positions of the upper reduced-width parts 10 and the lower reduced-width parts 11.

As shown in FIG. 4, second pleat fold lines 15, 15 are formed as valley fold lines as viewed from the front side of the mask body part 2 at a border between the respective folded parts 7, 7 and each of the side parts 8, 8. The second pleat fold lines 15, 15 are formed in an approximately vertical linear shape in the up-down direction.

As shown in FIGS. 1 and 7, of the first pleat fold lines 14 and the second pleat fold lines 15, respective upper end parts are joined at joining parts 16 at approximately the same respective positions and respective lower end parts are also joined at joining parts 17 at approximately the same respective positions.

### Configuration of Upper Reduced-Width Part, Lower Reduced-Width Part, First Pleat Fold Line, and Second Pleat Fold Line

In the present embodiment, the mask body part 2 and the facial contact body 3 are welded to each other at the upper end part 12 and the lower end part 13 of the mask 1. In addition, in the upper reduced-width parts 10, 10 and the lower reduced-width parts 11, 11, the upper ends and the lower ends of the first pleat fold lines 14, 14 and the second pleat fold lines 15, 15 are closer to each other than in the central part in the up-down direction or coincide with each other.

When the upper reduced-width parts 10, 10 and the lower reduced-width parts 11, 11 do not exist, the upper ends and the lower ends of the first pleat fold lines 14, 14 and the second pleat fold lines 15, 15 will be in a state of being separated from each other in a similar manner to the central part in the up-down direction. In addition, a portion of the mask 1 which is folded from above to below the upper end part 12 or a portion of the mask 1 which is folded from below to above the lower end part 13 are welded at the upper end part 12 or the lower end part 13. Therefore, the folded parts 7 in the portions being folded in and welded at the upper end part 12 or the lower end part 13 are unable to open when the mask body part 2 is made into a three-dimensional shape. This results in creating unnecessary creases or irregularities in a vicinity of the upper end part 12 or a vicinity of the lower end part 13 of the central portion 6 when the folded parts 7 are erected. Accordingly, a problem occurs in that forming and maintaining a shape that corresponds to the three-dimensional shape of the face of the wearer 100 becomes difficult, thereby causing discomfort when the wearer 100 wears the mask and making it difficult to ensure adherence to the face of the wearer 100.

On the other hand, in the present embodiment, the upper reduced-width parts 10, 10 and the lower reduced-width parts 11, 11 bring the first pleat fold lines 14, 14 and the second pleat fold lines 15, 15 close to each other at the upper end part 12 and the lower end part 13. Therefore, the folded parts 7 in the vicinities of the upper end part 12 and the lower end part 13 can also be erected without being affected by welding. Furthermore, even if there is a portion which is folded in from above the upper end part 12 or below the lower end part 13 and welded at the upper end part 12 or the lower end part 13, the portion will not affect the erection of the folded part 7. Therefore, according to the present embodiment, the mask 1 can be provided which easily enables the three-dimensional shape of the mask body part 2 corresponding to the three-dimensional shape of the face of the wearer 100 to be appropriately formed and maintained and which can be used while maintaining a comfortable fit.

However, as long as an advantageous effect of enabling the mask 1 to be used while maintaining the comfortable fit described above is produced, a configuration may be adopted in which only one of the upper reduced-width parts 10, 10 and the lower reduced-width parts 11, 11 exist or only one of the first pleat fold lines 14, 14 and the second pleat fold lines 15, 15 are brought close to each other or coincide with each other at the upper end part 12 or the lower end part 13.

Note that contrary to the present embodiment, the first pleat fold lines 14, 14 may be formed as valley fold lines and the second pleat fold lines 15, 15 may be formed as mountain fold lines.

### Outline of Facial Contact Body

The facial contact body 3 shown in FIG. 2 is provided at a position that comes into contact with the face of the wearer 100 on an inner side or, in other words, a rear-face side of the mask body part 2. For example, for the facial contact body 3, a non-breathable foam resin material to which a nonwoven fabric or pulp is attached and which has both high flexibility and high shape-restoring properties is used. In the present embodiment, a foaming rate of the facial contact body 3 is around 20 to 50.

As shown in FIG. 2, the facial contact body 3 is formed so that an outer peripheral part of the facial contact body 3 has an approximately hexagonal shape. For example, the facial contact body 3 is formed with a length (longest portion) in the left-right direction of approximately 105 mm and a length (longest portion) in the up-down direction of approximately 150 mm in a state of a rear view of the mask 1 shown in FIG. 2. In addition, the upper convex-upward portion above the facial contact body 3 is formed with a length (a length C shown in FIG. 1) in the up-down direction of approximately 40 mm and the lower convex-downward portion below the facial contact body 3 is formed with a length (a length D shown in FIG. 1) in the up-down direction of approximately 40 mm. However, these lengths differ depending on the size of the mask 1. For example, the length (approximately 150 mm) in the up-down direction of the facial contact body 3 described above represents a case of an M-size and, for example, an S-size is formed with a length in the up-down direction of approximately 120 mm and an L-size is formed with a length in the up-down direction of approximately 180 mm.

Note that the facial contact body 3 is not limited to the above and may assume any dimension or shape as long as the dimension or shape enables the facial contact body 3 to come into close contact with the face of the wearer 100 when in use to provide a favorable fit state and enables a dust-preventing function and an airborne droplet-preventing function to be realized.

The shapes and sizes of the upper end portion and the lower end portion of the facial contact body 3 are approximately the same as shapes and sizes of the mask body part 2 from the central portion 6 to positions close to the central portion 6 of the side parts 8. In addition, the upper end portion and the lower end portion of the facial contact body 3 are joined by welding by welder processing or the like to an upper end portion and a lower end portion of the mask body part 2 from the central portion 6 to positions of the side parts 8 close to the central portion 6. Note that the joining is not solely limited to welder processing and may be performed in any mode such as gluing and sewing.

As shown in FIG. 2, an annular peripheral edge part 19 with an annular shape as a “peripheral edge part” is formed in the facial contact body 3. An opening 18 is formed so as to open inside the annular peripheral edge part 19.

### Details of Facial Contact Body (Protruding Portion, Protrusion, Notch, etc.)

As shown in FIG. 2, in the annular peripheral edge part 19 of the facial contact body 3, a pair of protruding parts 20, 20, each of which protrudes from both sides toward a center direction of the opening 18, is provided and positioned at approximately the central part in the up-down direction. Each of the protruding parts 20, 20 is formed in, for example, an approximately rectangular shape with a length of approximately 25 mm or more in the left-right direction. As shown in FIG. 2, in a folded state, tip parts of the respective protruding parts 20, 20 (a right-side end part of the left-side protruding part 20 and a left-side end part of the right-side protruding part 20) face each other in close proximity with hardly any gap.

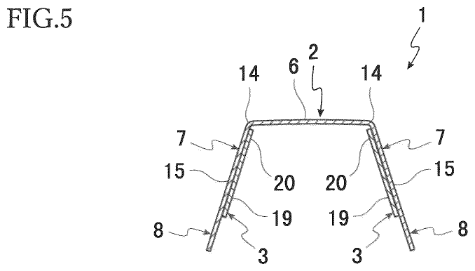

Lengths of the protruding parts 20, 20 in the left-right direction are formed larger than a length of a folded portion (a height in an erected state when in use) of the folded parts 7 of the mask body part 2. Specifically, as shown in FIG. 5, the protruding parts 20, 20 are constructed with a length that causes the protruding parts 20, 20 to come into contact with the erected folded parts 7 of the mask body part 2 when the protruding parts 20, 20 are folded from proximal end parts (a left-side end part of the left-side protruding part 20 and a right-side end part of the right-side protruding part 20) in a direction of a surface (a direction of the mask body part 2).

However, the length of the protruding parts 20 may be longer (for example, a length that causes tip parts to come into contact with the central portion 6) or shorter (for example, a length that causes the tip parts to approximately overlap with the second pleat fold lines 15) as long as a state where the folded parts 7 are erected can be stably maintained.

Lengths of the protruding parts 20, 20 in the up-down direction are lengths that enable respective central parts in the up-down direction to form a curved shape arcing outward from the upper side and the lower side when erected in the direction of the mask body part 2. The lengths of the protruding parts 20, 20 in the up-down direction in the present embodiment are formed to be approximately 54 mm or more and are desirably lengths equal to or longer than approximately 30 mm. This is because the protruding parts 20, 20 are to be fixed in the erected state by making the central parts in the up-down direction of the protruding parts 20, 20 curve outward.

Air holes 21, 21 are formed so as to open in approximately central portions of the respective protruding parts 20, 20. The air holes 21, 21 are formed with approximately rectangular openings with a length of approximately 10 mm in the left-right direction and approximately 20 to 23 mm in the up-down direction to reduce a contact area between the mask body part 2 and the facial contact body 3 and to ventilate front and back surfaces of the protruding parts 20, 20. The air holes 21, 21 may be formed in any size and shape as long as the front and back surfaces of the protruding parts 20, 20 can be ventilated and breathing of the wearer 100 can be favorably maintained when in use.

As shown in FIG. 2, a jaw protrusion 22 as a “protrusion” that protrudes upward from the central part in the left-right direction is provided below the annular peripheral edge part 19 of the facial contact body 3. The jaw protrusion 22 is formed in an approximately arc-like shape in which an upper end part of the jaw protrusion 22 is convex upward. However, the shape of the jaw protrusion 22 may be any other shape (for example, an approximately rectangular shape or an approximately triangular shape a peripheral edge part of an upper end part of which is convex upward) as long as the shape causes the jaw protrusion 22 to stably come into contact with the jaw of the wearer 100 when being worn.

Base end parts (lower end parts) that are positioned on both sides of the jaw protrusion 22 are provided with a pair of notches 23, 23. The notches 23, 23 are formed on a lower side of the annular peripheral edge part 19 in the form of diagonally downward notches on an extension of the approximately arc-like shape that is convex upward of the jaw protrusion 22. Accordingly, both notches 23, 23 are formed in shapes that widen downward. In the present embodiment, a lower width of the annular peripheral edge part 19 of the facial contact body 3 is formed, for example, to approximately 25 mm and the notches 23, 23 are formed as notches with a width of, for example, approximately 7 mm. The notches 23 may assume any shape or size as long as leakage of outside air and exhalation can be prevented while causing the jaw protrusion 22 to fit and come into contact with the jaw

### Of the Wearer 100.

Providing the notches 23, 23 enables the jaw protrusion 22 to change shapes while reducing the action of forces due to changes in shapes of the side parts and the upper part of the annular peripheral edge part 19. Therefore, the jaw protrusion 22 can be easily curved to a state where the jaw protrusion 22 fits the jaw of the wearer 100 (refer to [State When in Use (2. Curving of Facial Contact Body 3 and Wearing on Face)] to be described later).

Note that the notches 23, 23 may be formed in any shape (for example, a shape created by depressing a part of the annular peripheral edge part 19 in a curved shape that is convex downward or an approximately triangular shape or an approximately rectangular shape that is convex downward) as long as the shape is convenient in terms of curving the jaw protrusion 22 in a three-dimensional shape that conforms to the jaw of the wearer 100 and bringing the jaw protrusion 22 into close contact with the jaw when in use.

The notches 23, 23 are provided at positions that approximately overlap with the folded parts 7, 7 or the side parts 8, 8 of the mask body part 2 and are configured so that, when in use, the jaw protrusion 22 can be greatly curved as a three-dimensional shape (for example, a shape in which the tip part of the jaw protrusion 22 is bent toward the side of the mask body part 2) that conforms to the shape of the jaw at a position in the central part in the left-right direction from the erected folded parts 7, 7. The notches 23, 23 according to the present embodiment are provided at positions that approximately overlap with the second pleat fold lines 15 of the mask body part 2 and lengths in the up-down direction from the notches 23 to the tip of the jaw protrusion 22 are approximately 10 mm. However, the positions of the notches 23, 23 need not coincide with the second pleat fold lines 15 if the positions are compatible with the object described above.

As shown in FIG. 2, a pair of nasal bridge protrusions 24, 24 that protrudes diagonally downward from a vicinity of the central part in the left-right direction is provided above the annular peripheral edge part 19 of the facial contact body 3. The nasal bridge protrusions 24, 24 have a rectangular shape that is formed with a short-side length of approximately 10 mm and a long-side length of approximately 25 mm and come into contact with both sides of the nose of the wearer 100 in a state of close contact when in use. However, the nasal bridge protrusions 24, 24 may assume any position, size, and shape as long as the nasal bridge protrusions 24, 24 can come into contact with both sides of the nose of the wearer 100 in a state of close contact when in use.

As shown in FIG. 1, a band-shaped nose clip 25 is arranged along the upper end part 12 of the central portion 6 in a portion sandwiched between the mask body part 2 and the facial contact body 3. For example, the nose clip 25 is made of a material such as stretched polyethylene which is rigid and which can maintain its shape in a folded state.

The nose clip 25 is formed with a longitudinal length that is approximately the same as the size of the upper end part 12 in the left-right direction. The nose clip 25 is bent along the shape of the nose of the wearer 100 when worn so as to bring the mask body part 2 and the facial contact body 3 into close contact with the nose of the wearer 100. Note that the arrangement position and dimensions of the nose clip 25 are not limited to the above as long as functions of the nose clip 25 can be performed appropriately.

### Ear Straps

As shown in FIGS. 1 and 2, the ear straps 4, 4 are connected to both side parts in the left-right direction of the mask body part 2. The ear straps 4, 4 are each formed by an elastically stretchable rubber cord and formed to a length, such as 200 mm, which allows the mask 1 to fit and be worn on the face of the wearer 100. However, the lengths of the ear straps 4 may be longer or shorter than the length described above. In addition, the ear straps 4, 4 may be formed by known elastic materials such as non-woven or woven fabrics and plastic films.

### Connection Position of Ear Straps to Mask Body Part

Each of the ear straps 4, 4 is connected to the mask body part 2 at a position in the up-down direction on the borders between the vertical parts 9, 9 and the upper reduced-width parts 10, 10, and at a position in the up-down direction on the borders between the vertical parts 9, 9 and the lower reduced-width parts 11, 11 which is a position in the up-down direction at approximately equal distances from the upper end and the lower end of the mask body part 2. Specifically, both the left ear strap 4 and the right ear strap 4 are connected to the mask body part 2 at a position in the up-down direction that is ⅓ of the way from the upper end of the mask body part 2 and a position in the up-down direction that is ⅓ of the way from the lower end of the mask body part 2.

By connecting the ear straps 4, 4 to the mask body part 2 at these positions in the up-down direction, the folded parts 7 of the mask body part 2 can be erected and a three-dimensional shape can be stably maintained by tension in the left-right direction when in use.

In other words, since both end parts of both the left ear strap 4 and the right ear strap 4 are connected to the upper side and the lower side of the mask body part 2, there is a force between the upper and lower connection positions that brings the mask body part 2 closer in the up-down direction. The force that brings the mask body part 2 closer in the up-down direction acts as a strong force that erects the folded parts 7, 7 adjacent to the vertical parts 9 of the central portion 6 forward. Therefore, the folded parts 7 can be reliably and stably erected when in use.

On the other hand, in both the left ear strap 4 and the right ear strap 4, the force to erect the folded parts 7, 7 acts weaker with respect to an upper side of the upper connection position with the mask body part 2 and a lower side of the lower connection position with the mask body part 2 than between the connection positions.

In addition, in the present embodiment, the folded parts 7 on the upper side and the lower side of the connection positions of the ear straps 4, 4 to the mask body part 2 are adjacent to the upper reduced-width parts 10 and the lower reduced-width parts 11 of the central portion 6. Furthermore, in the folded parts 7 on the upper side and the lower side of the connection positions of the ear straps 4, 4 to the mask body part 2 and at the connection position of the upper end part 12 and the lower end part 13, the first pleat fold lines 14, 14 and the second pleat fold lines 15, 15 are joined to form joined parts 16, 16 and joined parts 17, 17. Therefore, the folded parts 7 on the upper side and the lower side of the connection positions of the ear straps 4, 4 to the mask body part 2 are smaller in width than between the connection positions and a force required to erect the folded parts 7 is smaller. As a result, the folded parts 7 at positions adjacent to the upper reduced-width parts 10 and the lower reduced-width parts 11 are reliably and stably erected even with a small force. Therefore, the three-dimensional shape of the mask body part 2 when in use can be made to appropriately achieve the object of the mask 1 and a state where the mask body part 2 assumes a three-dimensional shape can be stably maintained.

The connection position between the ear straps 4, 4 and the mask body part 2 may be any position other than the positions described above as long as the position is in accordance with the object of maintaining the three-dimensional shape of the mask body part 2 in a stable manner. For example, only the upper ends or the lower ends of the ear straps 4, 4 may be connected to a position in the up-down direction that is approximately ⅓ from the upper end or the lower end of the mask body part 2 or the ear straps 4, 4 may be connected to a position that is closer to the center in the up-down direction than approximately ⅓ from the upper end or the lower end of the mask body part 2 such as a position in the up-down direction that is approximately ⅖ from the upper end or the lower end. Alternatively, the ear straps 4, 4 may be connected to a position closer to the center in the up-down direction than the border parts between the vertical parts 9 and the upper reduced-width parts 10 or the border parts between the vertical parts 9 and the lower reduced-width parts 11 such as any position corresponding to the positions where the vertical parts 9, 9 of the mask body part 2 are formed.

### Strap Clip

As shown in FIGS. 1 and 2, a strap clip 5 is connected to each ear strap 4. The strap clip 5 is made of a rigid material such as hard resin and is formed in an approximately annular shape with a constricted central portion. The strap clips 5, 5 are used to adjust the length of the ear straps 4 by inserting and engaging one annular portion inside the other annular portion. Note that the strap clips 5, 5 need not be provided.

In addition, instead of the pair of left and right ear straps 4, 4 according to the present embodiment, the mask 1 may be provided with a headband-style strap which is connected on both left and right sides and which presents an approximately annular shape together with the mask body part 2. In this case, the strap is used by being passed over the back of the wearer's head from the side of the wearer's head.

### State When Not in Use and State When in Use Next, a state when not in use and a state when in use of the mask according to the present embodiment will be described.

### State When Not in Use

As shown in FIGS. 1 and 4, in a state when the mask 1 according to the present embodiment is not in use, the folded parts 7 of the mask body part 2 are folded, and further, as shown in FIG. 2, the protruding parts 20, 20, the jaw protrusion 22, and the nasal bridge protrusions 24, 24 of the facial contact body 3 form approximately the same plane as the annular peripheral edge part 19 and creates a flat shape. Accordingly, since the mask 1 is not bulky when packaged, the mask 1 can be extremely easily transported and stored.

### State When in Use (1. Formation of Three-Dimensional Shape)

Next, when the mask 1 is in use, the wearer 100 pulls the ear straps 4, 4 in the left-right direction or pulls the folded parts 7, 7 forward (in the direction of the mask body part 2: the same applies in the present specification), which creates a state in which the folded parts 7, 7 are erected approximately vertically in front of the mask body part 2. Accordingly, as shown in FIGS. 5 and 7, a three-dimensional shape in which the central portion 6 protrudes forward with respect to the side parts 8 is formed.

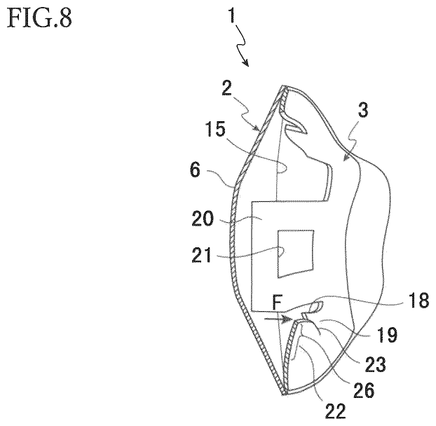

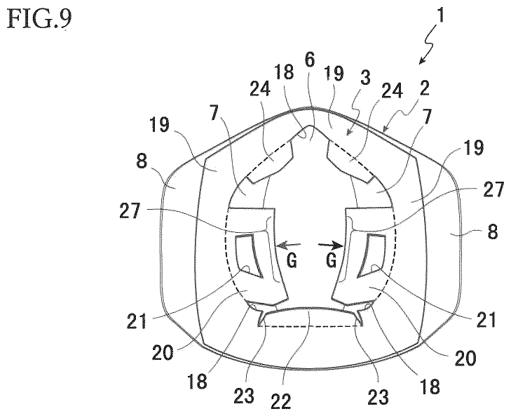

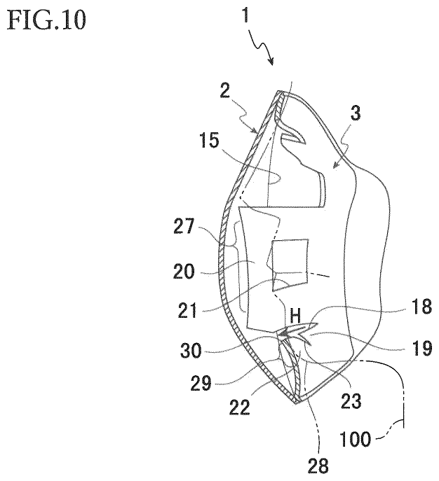

In this state, when the protruding parts 20, 20 of the facial contact body 3 are folded forward, the protruding parts 20, 20 press the folded parts 7, 7 in a direction of erecting the folded parts 7, 7 and an erected state of the folded parts 7, 7 can be maintained stably (refer to FIGS. 5 and 8). At this point, a force in a direction indicated by an arrow G in FIG. 9 acts on the approximately central part in the up-down direction of the protruding parts 20, 20. In addition, as shown in FIGS. 9 and 10, the approximately central part in the up-down direction of the protruding parts 20, 20 forms curved parts 27, 27 with a curved shape that bulges in the left-right direction. The formation of the curved parts 27 allows the erected state of the protruding parts 20, 20 to be maintained stably.

Furthermore, situations where the erected protruding parts 20, 20 collapse or become crushed when in use can be prevented and the three-dimensional shape of the mask body part 2 can be maintained stably.

In addition, in this state, when the wearer 100 arranges his/her nose and mouth inside the opening 18 of the facial contact body 3 of the mask 1 and hooks the ear straps 4, 4 around his/her ears after forming a state where the annular peripheral edge part 19 comes into contact with the nose and mouth, the nasal bridge protrusions 24, 24 come into contact with both side parts of the nose and the jaw protrusion 22 comes into contact with the jaw. In doing so, when the lengths of the ear straps 4, 4 are too short, the mask 1 can also be worn by adjusting the lengths of the ear straps 4 by inserting and engaging one strap clip 5 into an annular portion of the other strap clip 5.

### State When in Use (2. Curving of Facial Contact Body 3 and Wearing on Face)

When a force in the left-right direction is applied to the facial contact body 3 due to the tension of the ear straps 4, 4 and the like, the force acts on the upper and lower connection portions of the respective ear straps 4, 4 of the facial contact body 3 to the mask body part 2 as a force in the direction of bringing thee connection portions closer to each other. The force acts as a force to maintain the curved parts 27, 27 formed on the erected protruding parts 20 of the facial contact body 3 shown in FIGS. 9 and 10 and can prevent a situation where the erected protruding parts 20, 20 collapse or become crushed.

In addition, the force by the ear straps 4, 4 in the left-right direction of the facial contact body 3 described above causes the annular peripheral edge part 19 on the lower side of the facial contact body 3 to bulge to the rear side (the side in contact with the face of the wearer 100 as indicated by an arrow F in FIG. 8). When the force is applied to the jaw protrusion 22 as it is, as shown in FIG. 8, the jaw protrusion 22 forms a bulging part 26 that bulges to the rear side (a right side in FIG. 8).

On the other hand, in the present embodiment, notches 23, 23 are formed in both lower end parts of the jaw protrusion 22. In addition, as shown in FIG. 10, the jaw 28 of the wearer 100 comes into contact with the jaw protrusion 22. Furthermore, as indicated by an arrow H in FIG. 10, a pressing force toward the front side (a left side in FIG. 10) is applied to the jaw protrusion 22 by the jaw 28. In addition, because of the presence of the notches 23, 23, a curved part 29 which curves to the front side is formed in the jaw protrusion 22 by the pressing force of the jaw 28 while the annular peripheral edge part 19 on both sides of the jaw protrusion 22 is kept curved to the rear side. Accordingly, the annular peripheral edge part 19 can be brought into contact with the mouth area and the like of the wearer 100 and, at the same time, the jaw protrusion 22 can be brought into contact with the jaw 28 of the wearer 100 in a favorable close contact state.

Furthermore, the jaw protrusion 22 flexibly deforms and comes into contact with the jaw 28 in accordance with the size of the face and the position of the jaw of the wearer 100. Therefore, when the face of the wearer 100 is large, as shown in FIG. 10, approximately the entire surface of the jaw 28 of the wearer 100 comes into contact with the jaw protrusion 22 and the large curved part 29 is formed in the jaw protrusion 22. On the other hand, when the face of the wearer 100 is small, the curved part 29 of the jaw protrusion 22 is hardly formed and only a tip part 30 of the jaw protrusion 22 shown in FIG. 10 comes into contact with the jaw 28 of the wearer 100. In this manner, the mask 1 according to the present embodiment can be worn in a favorable fit by bringing the facial contact body 3 into close contact with the face of the wearer 100 by changing the contact position of the jaw 28 of the wearer 100 with respect to the jaw protrusion 22 and the formation state of the curved part 29 regardless of differences in the size of the face of the wearer 100 or the contact position of the face with respect to the mask 1.

Furthermore, when the nose clip 25 is bent into an approximately V-shape in the front-back direction along the ridge shape of the nose of the wearer 100, the upper side of the mask body part 2 comes into close contact with the nose portion of the wearer 100.

In this manner, the mask 1 according to the present embodiment forms a three-dimensional shape in a state of close contact with the face of the wearer 100 and is worn in a state where the nose and the mouth of the wearer 100 are covered.

In the mask 1 according to the present embodiment, the first pleat fold lines 14 and the second pleat fold lines 15 of the mask body part 2 are positioned and formed on both sides of the nose and mouth area of the wearer 100 in an approximately vertical direction and the folded parts 7 are erected along the vertical direction of the face of the wearer 100. In addition, the protruding parts 20, 20, the jaw protrusion 22, and the nasal bridge protrusions 24, 24 of the facial contact body 3 are erected forward to form a three-dimensional shape and maintain the three-dimensional shape of the mask body part 2. Therefore, the three-dimensional shape of the mask body part 2 when in use is to be formed along an approximately vertical direction that conforms to a three-dimensional shape (a direction of the bridge of the nose, a direction of nasolabial folds of the mouth area, or the like) of the face of the wearer 100.

Therefore, even when the wearer 100 speaks or moves muscles of expression while using the mask, situations where the three-dimensional shape of the mask body part 2 inhibits movements of the muscles of the face are prevented. Furthermore, the three-dimensional shape formed by the mask body part 2 and the facial contact body 3 continuously form a state of close contact of the mask 1 with the nose and mouth area of the wearer 100. Accordingly, a favorable and comfortable fit state of the mask 1 can be maintained with respect to the wearer 100.

In addition, due to tension of the ear straps 4, 4 in the left-right direction, the folded parts 7 of the mask body part 2 can be erected and a three-dimensional shape can be stably maintained (refer to [Connection Position of Ear Straps to Mask Body Part] described above).

### Advantageous Effects

As described above, in the present invention, the mask 1 includes the central portion 6, the folded parts 7, 7 which are folded along the longitudinal direction of the mask body part 2, and side parts 8, 8 which are connected to the sides of the folded parts 7, 7, so that a three-dimensional shape along the longitudinal direction of the mask body part 2 is formed. The three-dimensional shape can easily accommodate the irregularities of the face of the wearer 100 and allows the mask 1 to be worn stably in a state of close contact with a periphery of the nose and mouth area of the wearer 100. In addition, the central portion 6 includes the upper reduced-width parts 10, 10 and the lower reduced-width parts 11, 11 each having a width in the left-right direction reduced upward and downward from the central part in the up-down direction, so that the folded parts 7, 7 are smoothly erected by a force applied in the left-right direction of the mask body part 2 due to tension of the ear straps 4, 4 or the like to form a three-dimensional shape and the three-dimensional shape with the raised central portion 6 of the mask body part 2 can thus be easily formed and maintained. Accordingly, the mask 1 which can easily form a three-dimensional shape that ensures favorable adherence to the face of the wearer 100 when in use and which can easily be maintained in a favorable state of use can be provided.

In addition, in the present invention, respective upper end parts and respective lower end parts of the first pleat fold lines 14, 14 formed at respective borders between the folded parts 7, 7 and the central portion 6 and the second pleat fold lines 15, 15 formed at respective borders between the folded parts 7, 7 and the side parts 8, 8 are formed as the joined parts 16, 16 and/or the joined parts 17, 17 at approximately the same respective positions, so that, even when the upper end part 12 and the lower end part 13 of the mask body part 2 and the folded parts 7, 7 are joined including the first pleat fold lines 14, 14 and the second pleat fold lines 15, 15, a state of the joint can be prevented from affecting the erection of the folded parts 7, 7. Accordingly, the mask 1 can be provided which easily enables the three-dimensional shape of the mask body part 2 corresponding to the three-dimensional shape of the face of the wearer 100 to be appropriately formed and maintained and which can be used while maintaining a comfortable fit.

Furthermore, in the present embodiment, the central portion 6 includes the upper reduced-width parts 10, 10 and the lower reduced-width parts 11, 11 each having a width in the left-right direction reduced upward and/or downward from the central part in the up-down direction, so that the upper reduced-width parts 10, 10 and the lower reduced-width parts 11, 11 can be erected by a small force when a force is applied in the left-right direction of the mask body part 2 due to tension of the ear straps 4, 4 or the like. In addition, the folded parts 7, 7 are smoothly erected to form a three-dimensional shape and the three-dimensional shape with the raised central portion of the mask body part 2 can be easily formed and maintained. Furthermore, the protruding parts 20, 20 include a tip part formed with a predetermined length along the up-down direction, and when the wearer 100 uses the mask, the tip part of the protruding parts 20, 20 comes into contact with the central portion 6 or the folded parts 7, 7 and presses the central portion 6 from the inside to the outside, thereby enabling the folded parts 7, 7 to be easily erected and form a three-dimensional shape. Accordingly, a shape corresponding to the three-dimensional shape of the face of the wearer 100 can be more easily formed and maintained, ensuring a comfortable fit for the wearer 100 and even more favorable adherence to the face of the wearer 100.

In addition, in the present embodiment, the respective attachment portions of the ear straps 4, 4 to the mask body part 2 are connected to the mask body part 2 at positions in an upper direction where the upper reduced-width parts 10, 10 are provided and positions in a lower direction where the lower reduced-width parts 11, 11 are provided which are positions in the up-down direction approximately equally distanced from the upper end part 12 and the lower end part 13 of the mask body part 2, so that the folded parts 7, 7 of the mask body part 2 can be erected and the three-dimensional shape can be stably maintained by tension in the left-right direction produced by the ear straps 4, 4 when in use.

Furthermore, in the present embodiment, since the mask 1 includes the facial contact body 3 which is provided on an inner side and which comes into contact with the face of the wearer 100 so that the mask can be easily and snugly attached to the face of the wearer, the wearer 100 can be reliably prevented from inhaling external harmful substances or viruses and airborne droplets and the like contained in the exhalation of the wearer 100 can be reliably prevented from being dispersed outside.

### First Modification: Configuration of Central Portion

While the central portion 6 of the mask body part 2 is formed in an approximately octagonal shape that is left-right symmetrical and approximately up-down symmetrical as a shape in a front view in the present embodiment, the shape in a front view of the central portion 6 is not limited thereto.

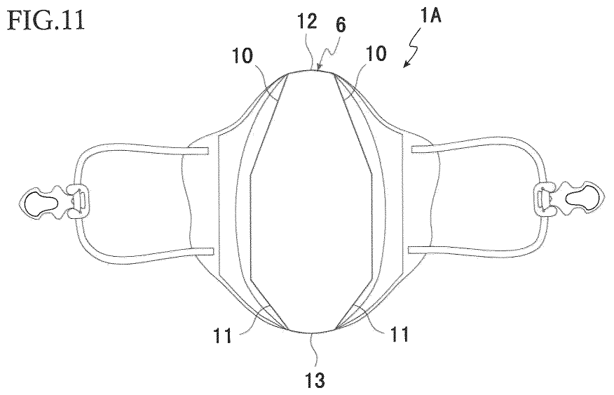

For example, as outlined as a mask 1A in FIG. 11, the upper reduced-width parts 10, 10 of the central portion 6 may be formed longer and the lower reduced-width parts 11, 11 of the central portion 6 may be formed shorter. Conversely, the upper reduced-width parts 10, 10 may be formed shorter and the lower reduced-width parts 11, 11 may be formed longer. In addition, the central portion 6 may be configured without the lower reduced-width parts 11, 11 (a configuration made up of the upper reduced-width parts 10, 10, the vertical parts 9, 9, the upper end part 12, and the lower end part 13) or configured without the upper reduced-width parts 10, 10 (a configuration made up of the lower reduced-width parts 11, 11, the vertical parts 9, 9, the upper end part 12, and the lower end part 13).

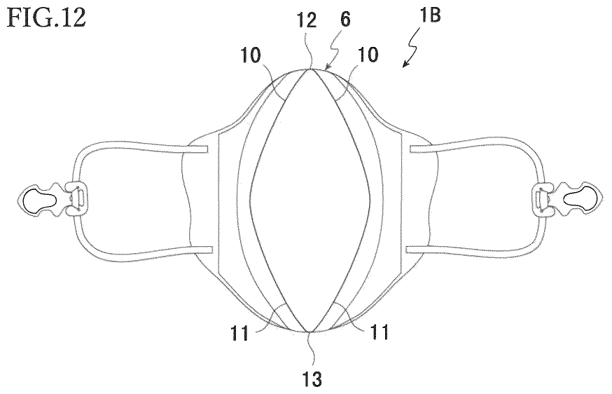

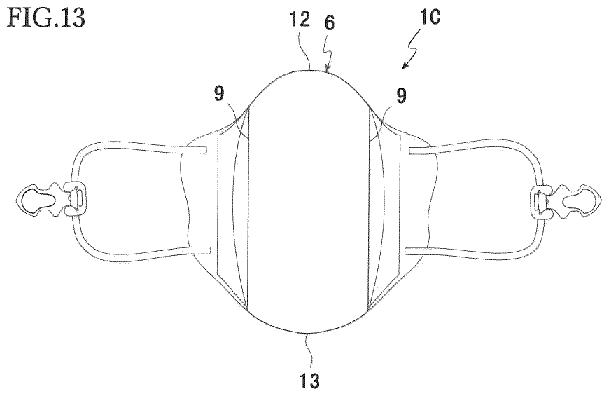

In addition, the front view of the central portion 6 may be formed in a front view shape other than an approximately octagonal shape. Specifically, for example, the central portion 6 may be configured without the vertical parts 9, 9 and with only the upper reduced-width parts 10, 10 and the lower reduced-width parts 11, 11 so that the front view shape of the central portion 6 assumes an approximately hexagonal shape, an approximately rhombic shape (the upper end part 12 and the lower end part 13 are pointed) as outlined as a mask 1B in FIG. 12, or the like. In addition, the front view shape may be an approximately decagonal shape, an approximately dodecagonal shape, or the like or an up-down asymmetrical shape such as an approximately triangular shape or an approximately trapezoidal shape. Furthermore, the front view shape of the central portion 6 may assume an approximately elliptical shape by forming the upper reduced-width parts 10, 10 and the lower reduced-width parts 11, 11 in an approximately curved shape or some sides of the various shapes described above may be formed in an approximately arc-like shape. Moreover, as outlined as a mask 1C in FIG. 13, a configuration made up of the vertical parts 9, 9, the upper end part 12, and the lower end part 13 without providing the upper reduced-width parts 10, 10 and the lower reduced-width parts 11, 11 may be adopted (although not illustrated, the central portion 6 may be configured in an approximately rectangular shape with the upper end part 12 and the lower end part 13 assuming approximately horizontal shapes).

In addition, the ratio of the length in the up-down direction and the length in the left-right direction of the front view shape of the central portion 6 may be any ratio. For example, the central portion 6 may be any ratio such as 150 mm-long in the up-down direction and 45 mm-long in the left-right direction (aspect ratio 3.3:1), 150 mm-long in the up-down direction and 60 mm-long in the left-right direction (aspect ratio 2.5:1), and aspect ratios of 2.1:1, 1.9:1, 1.5:1, . . . .

Although not illustrated, the configurations of the upper reduced-width parts 10, 10 and the lower reduced-width parts 11, 11 and the configurations of the first pleat fold lines 14, 14 and the second pleat fold lines 15, 15 may differ from those shown in FIGS. 1 to 10 so as to correspond to the configuration of the central portion 6. For example, when the central portion 6 is configured without the lower reduced-width parts 11, 11, a configuration may be adopted in which the first pleat fold lines 14, 14 and the second pleat fold lines 15, 15 (refer to FIG. 4) do not coincide with each other at the lower end part 13 or, conversely, when the central portion 6 is configured without the upper reduced-width parts 10, 10, a configuration may be adopted in which the first pleat fold lines 14 and the second pleat fold lines 15 (refer to FIG. 4) do not coincide with each other at the upper end part 12.

### Second Modification: Configuration of Protruding Part

In addition, while the protruding parts 20, 20 are positioned at an approximately central part in the up-down direction of the facial contact body 3 and formed in an approximately rectangular shape in a front view in the present embodiment, the protruding parts 20, 20 are not limited thereto.

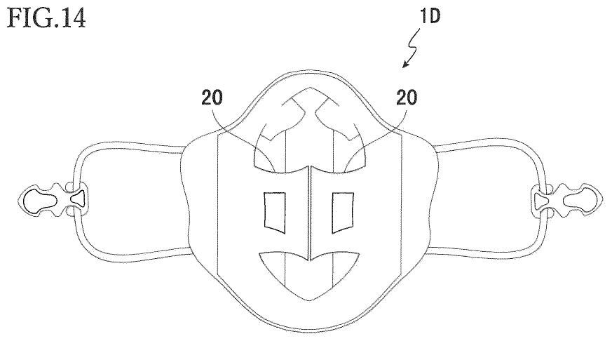

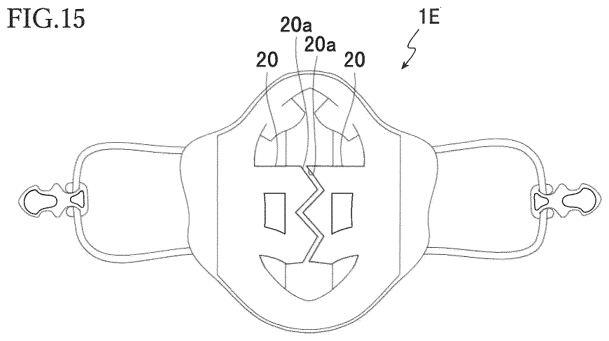

For example, an upper side part and a lower side part of each of the protruding parts 20, 20 may form an approximately arc-like shape that bulges in the up-down direction at the central part in the left-right direction or may form an approximately arc-like shape in which the upper side part and the lower side part approach each other as outlined as a mask 1D in FIG. 14. In addition, the size of the protruding parts 20, 20 in the up-down direction may be enlarged or reduced from the distal end parts toward the tip parts or the tip parts may be beveled. Furthermore, the tip parts of the protruding parts 20, 20 need not be straight in the up-down direction (for example, tip parts 20a, 20a may have a zigzag shape as outlined as a mask 1E in FIG. 15).

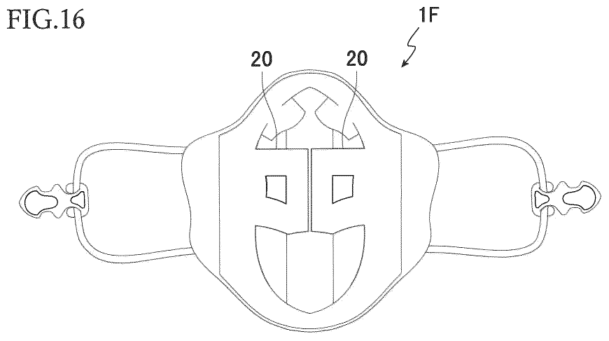

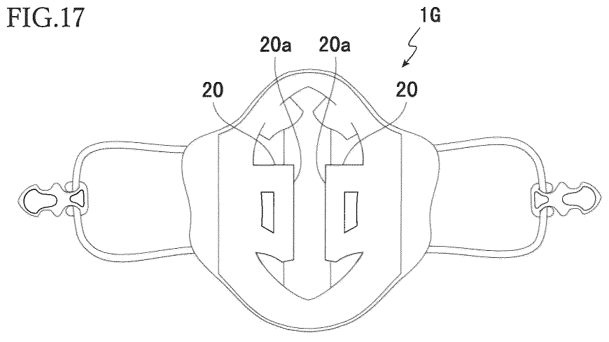

In addition, as outlined as a mask 1F in FIG. 16, the protruding parts 20, 20 may be provided closer to the top or bottom than the approximately central part in the up-down direction or may have an up-down asymmetrical shape (for example, an approximately trapezoidal shape that is up-down asymmetrical). Furthermore, the protruding parts 20, 20 are not limited to one on each of the left and right sides but two or more may be provided on each of the left and right sides. In addition, the respective tip parts of the left and right protruding parts 20, 20 need not be in close proximity to each other and the tip parts 20a, 20a of the left and right protruding parts 20, 20 may be spaced apart as outlined as a mask 1G in FIG. 17.

### Third Modification: Configuration of Jaw Protrusion and Notch

In addition, while the upper edge part of the jaw protrusion 22 is formed in an approximately arc-like shape that is convex upward in the present embodiment, the jaw protrusion 22 is not limited thereto.

For example, the jaw protrusion 22 may be formed in shapes such as an approximately rectangular shape, an approximately triangular shape, or an approximately pentagonal shape that is convex upward. In addition, the jaw protrusion 22 may be formed in an approximately arc-like shape on an extension of the annular peripheral edge part 19 or the upper end part may be formed in a shape that conforms to a curvature of the jaw (for example, an approximately arc-like shape which protrudes upward and a central part of an upper end part of which is depressed). Furthermore, the upper edge of the jaw protrusion 22 may assume a shape that conforms to the lower edges of the notches 23, 23.

While the notches 23, 23 according to the present embodiment are formed on a lower side of the annular peripheral edge part 19 in the form of diagonally downward notches on an extension of an approximately arc-like shape that is convex upward of the jaw protrusion 22 and which widen downward, the notches 23, 23 are not limited thereto.

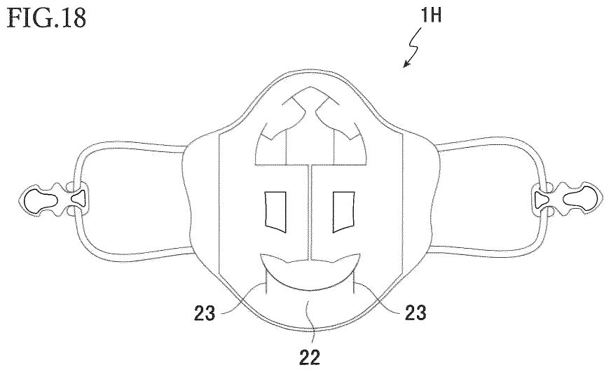

For example, the notches 23, 23 may be made in a shape notched in an approximately vertical direction on an extension of the approximately rectangular or approximately semicylindrical jaw protrusion 22 protruding upward, a shape notched in an approximately vertical direction in both side parts of the jaw protrusion 22 formed by being depressed lower than the annular peripheral edge part 19, or in the base end part of the approximately arc-like jaw protrusion 22 that is convex upward, as outlined as a mask 1H in FIG. 18, a pair of downward notches may be made on the extension of the lower annular peripheral edge part 19 to form the notches 23, 23 and a central side in the left-right direction of the pair of notches 23, 23 may be adopted as the jaw protrusion 22.

In addition, a part of the notched jaw protrusion 22 may be formed in a shape that narrows downward.

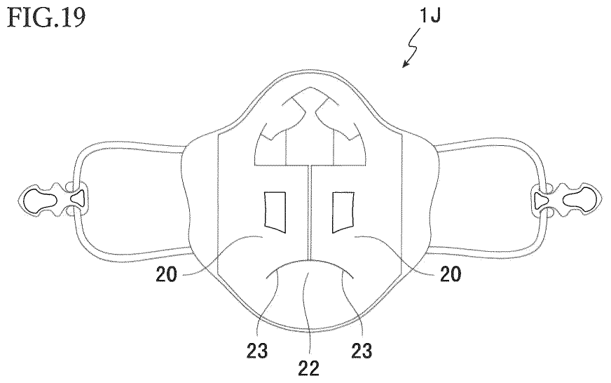

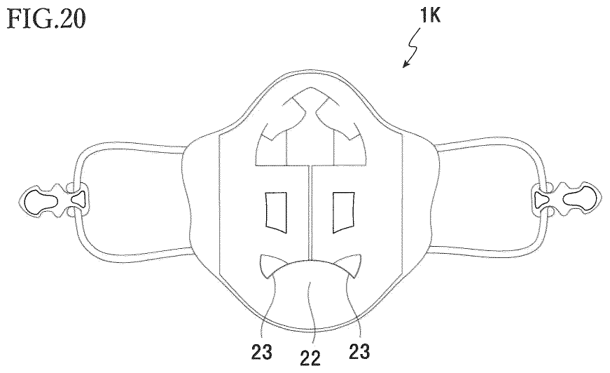

Furthermore, as outlined as a mask 1J in FIG. 19, a state where there is no gap between the protruding parts 20, 20 that protrude from left and right and the jaw protrusion 22 or a state where the protruding parts 20, 20 and the jaw protrusion 22 approach each other may be formed. In addition, as outlined as a mask 1K in FIG. 20, the notches 23, 23 may be configured as approximately V-shaped notches (or notches with other shapes such as approximately U-shaped or approximately C-shaped notches) instead of being shaped as notched lines.

### Fourth Modification: Configuration of Nasal Bridge Protrusion

In addition, while each of the nasal bridge protrusions 24, 24 is formed in an approximately rectangular shape protruding obliquely downward from a vicinity of the central part in the left-right direction of the annular peripheral edge part 19 in the present embodiment, the nasal bridge protrusions 24, 24 are not limited thereto.

It is needless to say that the embodiment described above represents an example of the present invention and that the present invention is not solely limited to the embodiment described above.

### REFERENCE SIGNS LIST

1 mask
2 mask body part
3 facial contact body
4 ear strap
6 central portion
7 folded part
8 side part
10 upper reduced-width part (reduced-width part)
11 lower reduced-width part (reduced-width part)
18 opening
19 annular peripheral edge part (peripheral edge part)
20 protruding part
21 air hole
22 jaw protrusion (protrusion)
100 wearer

1. A mask, comprising:
a mask body part which is exposed to outside when worn on a face of a wearer; and
ear straps arranged on respective sides of the mask body part, wherein
the mask body part includes
a central portion which covers a central part in a left-right direction of the face of the wearer along a longitudinal direction,
folded parts which are connected to sides of the central portion and which are folded along a longitudinal direction of the mask body part, and
side parts which are connected to sides of the folded parts and which cover sides of the face of the wearer,
the central portion includes reduced-width parts each having a width in a left-right direction reduced upward and/or downward from a central part in an up-down direction, and
the mask body part is configured such that
the folded parts are folded and form a flap shape when the wearer is not using the mask and
the folded parts are erected by tension of the ear straps to form a three-dimensional shape when the wearer is using the mask.

2. The mask according to claim 1, further comprising:
first pleat fold lines formed at respective borders between the folded parts and the central portion; and
second pleat fold lines formed at respective borders between the folded parts and the side parts, wherein
respective upper end parts and/or respective lower end parts of the first pleat fold lines and the second pleat fold lines are formed at approximately same respective positions.

3. The mask according to claim 1, wherein
the central portion includes vertical parts which are positioned at least in the central part in the up-down direction and which are provided in an approximately vertical direction and the reduced-width parts which are positioned and provided above and/or below the vertical parts, respectively, and
the ear straps are connected to the mask body part at respective upper and lower positions approximately equal to border parts between the vertical parts and the reduced-width parts, respectively, and/or at respective upper and lower positions closer to the central part in the up-down direction than the border parts.

4. The mask according to claim 1, wherein respective attachment portions of the ear straps to the mask body part are connected to the mask body part at positions in the up-down direction where the reduced-width parts are provided which are positions in the up-down direction approximately equally distanced from an upper end and a lower end of the mask body part.

5. The mask according to claim 1, further comprising a facial contact body which is provided on an inner side of the mask body part and which comes into contact with the face of the wearer.

6. The mask according to claim 2, further comprising a facial contact body which is provided on an inner side of the mask body part and which comes into contact with the face of the wearer.

7. The mask according to claim 3, further comprising a facial contact body which is provided on an inner side of the mask body part and which comes into contact with the face of the wearer.

8. The mask according to claim 4, further comprising a facial contact body which is provided on an inner side of the mask body part and which comes into contact with the face of the wearer.
